(19) United States
(12) Patent Application Publication
(10) Pub. No.: US 2007/0038535 A1
(43) Pub. Date: Feb. 15, 2007

(54) Retirement income option

(75) Inventors: Matthew N. Hulsizer, Winnetka, IL (US); Joseph P. Just, Glenview, IL (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: PEAK6 Investments, L.P.

(21) Appl. No.: 11/199,648

(22) Filed: Aug. 9, 2005

(51) Int. Cl. G06Q 40/00

(52) U.S. Cl. 705/35

(57) ABSTRACT

An option is provided to hedge against the risk of a reduction in retirement benefits or a change in the timing of when such benefits are received,. The option may also be used to hedge against reductions in returns from Social Security and retirement savings plans. The option is standardized in that it provides protection against an identifiable set of potential modifications to Social Security retirement benefits and the timing of such benefits as well as reductions in returns from retirement savings plans. At the same time, each option is customized for each purchaser based upon the purchaser's age, income level, investment mix, desired return and other factors.

### BACKGROUND OF THE INVENTION

1. Field of the Invention

The present invention relates to a retirement income option and more particularly to a financial product and method for hedging against prospective changes in retirement income resulting from, for example, reductions in benefits and/or the timing of benefits from Social Security and returns from retirement savings plans, including defined contribution plans, such as 401(k) plans, 403(b) plans, employee stock ownership plans and profit sharing plans, and thrift savings plans, as well as other retirement income funding sources to enable retirees to rely on fixed prospective retirement income.

2. Description of the Prior Art

Following retirement from employment, many individuals are known to rely on their Social Security retirement benefits as a source of retirement income. Individuals are also known to attempt to supplement future retirement income by participating in retirement savings plans, and other investment accounts. While diversification allows an individual to better prepare for retirement, Social Security benefits are the chief source of income for many retirees. As a result, any reduction in retirement benefits, such as a reduction in Social Security retirement benefits or the timing of such benefits, could have a significant adverse impact on such persons upon retirement.

In recent years, concern has grown regarding the overall stability and solvency of the Social Security system. A variety of reform plans have been proposed to strengthen the Social Security system, many of which could result in a reduction in future benefits for retirees and/or changes in eligibility requirements. In addition, fluctuations and instability in the markets have resulted in lower than anticipated returns (including, in many cases, negative returns) in many workers' retirement savings plans. To enhance retirement income, various financial products have been developed to increase retirement benefits. For example, US Patent Application Publication No. US 2002/016181, published on Oct. 31, 2002, now U.S. Pat. No. 6,625,582, issued on Sep. 23, 2003, and US Application Publication No. US 2004/0158517, published on Aug. 12, 2004, disclose a method for optimizing retirement income by deferring Social Security retirement income and using a bridge investment to fund retirement income until Social Security retirement benefits commence. In order to maximize retirement benefits, a financial model is developed. Various financial and personal information about an individual is used to develop the financial model and includes the age of the individual and their planned retirement date. This information is used to ascertain when the maximum Social Security retirement benefits will be realizable for the individual. The financial model is based on deferring Social Security benefits until the maximum retirement benefit is realizable and funding the retirement benefits with a private bridge investment product to cover the period from an individual's planned retirement date until the date the Social Security retirement benefits are at a maximum. Income from the private bridge investment product can also be wrapped around Social Security retirement benefits to provide enhanced income after the deferred Social Security retirement benefits commence. For individuals that are married, spousal personal and financial data is also included in the model.

Unfortunately, the financial model disclosed in the above-mentioned publications is based upon current Social Security benefit levels and retirement dates for maximum retirement benefits. It does not take into account changes in Social Security benefit levels or the timing of benefits which are likely to have an adverse impact on retirement income.

A problem also exists with retirement savings plans, including defined contribution plans, also known to be used to fund retirement benefits. Under current regulations, plan participants have an option to self-direct investment of qualified funds under the plan. In particular, if a plan participant elects to self-direct investment of plan funds, the plan participant can invest in various investment options. Should the plan participant make unwise investment choices, the plan funds may be partially or totally depleted. Since many individuals are known to rely on the principal and income from such retirement savings plans to supplement retirement income, such depleted principal and income can further reduce retirement income. Thus, there is a need to provide a hedge against changes in Social Security retirement benefits and/or reduction in value of retirements savings plan assets as well as other retirement income funding sources, such that retirees can rely on fixed prospective retirement income levels.

### SUMMARY OF THE INVENTION

Briefly, the present invention relates an option contract (“option”) as a hedge against the risk of a reduction in retirement benefits or a change in the timing of when such benefits are received. In particular, the option may be used to hedge against reductions in Social Security benefits and/or the timing of such benefits as well as assets in retirement savings plans and other retirement income funding sources. The option is standardized in that it provides protection against an identifiable set of potential modifications to, for example, Social Security retirement benefits and the timing of such benefits as well as reductions in the assets of a retirement savings plan and other retirement income finding sources. At the same time, each option is customized for each purchaser based upon the purchaser's age and optionally one or more additional factors, such as, income level, investment mix, desired return and other factors.

### DESCRIPTION OF THE DRAWING

These and other advantages of the present invention are readily understood from the following specification and attached drawing wherein:

FIG. 1 is a block diagram illustrating a method in accordance with the present invention for hedging against fluctuations in funding sources for retirement income.

### DETAILED DESCRIPTION

A financial product and a method are provided to hedge against the risk of a reduction in retirement benefits or a change in the timing of when such benefits are received. In particular, an option contract is provided to hedge against such reductions in prospective retirement income. The option is standardized in that it provides protection against an identifiable set of potential modifications to Social Security retirement benefits. At the same time, each option is customized for each purchaser based upon the purchaser's age and optionally one or more additional factors, such as, income level, investment mix, desired return and other factors.

### Options in General

A typical option is an agreement either to buy or sell an underlying asset at a predetermined price on or before a specified date in the future. More specifically, an option contract gives the buyer or holder of the option the right, but not the obligation, to buy or sell an underlying asset at a specific price on or before a certain predetermined date, while the option seller or writer has an absolute obligation to perform under the option. An option's value depends on the value of the underlying asset or variable at a predetermined point in time in the future (e.g., the value of a stock option is based on the valuation of the underlying stock to which it refers).

Exchange-traded options are standardized contracts which are traded on a variety of organized exchanges in the United States in a regulated exchange environment. Over the counter (OTC) options are privately negotiated bilateral contracts executed outside of the regulated exchange environment. There is no central marketplace or clearinghouse for OTC options. Market-makers, primarily large investment banks, commercial banks and institutional proprietary trading firms, create OTC options for use by a wide range of corporate, individual and institutional end-users.

Investors trading options or other derivative securities primarily are concerned with hedging the risk of adverse price and market fluctuations, which may affect their potential returns and positions in underlying assets. Investors may utilize exchange-traded options and OTC options for a variety of reasons, including the following:
Liquidity—to generate additional income from an existing asset and create a measure of downside protection.
Risk Reduction—to reduce or eliminate exposure to a change in the value of an asset.
Diversification—to reduce the risk of a concentrated position in an asset by investing in a more balanced, diversified portfolio.
Monetization—to increase liquidity by borrowing money using a protected position in an asset as collateral.
Tax Deferral—to avoid triggering a taxable sale of the position in the underlying asset, thereby deferring the capital gains tax associated with an outright sale of the asset.

### Characteristics and Types of Options

There are two types of options—puts and calls. An option which gives the holder a right to buy the underlying asset is referred to as a call option (a “call”), and an option which gives the holder a right to sell the underlying asset is a put option (a “put”). If the option can only be exercised at a specific point in the future, it is considered a “European style” option, while an option that can be exercised at any point prior to maturity is considered an “American style” option.

The exercise price, also called the strike price, of an option is the price at which the buyer of an option may buy the underlying asset from the seller of an option (in the case of a call option) or sell the underlying asset to the seller of an option (in the case of a put option).

Options may be either physically settled or cash settled. The buyer of a physically settled option has the right to receive physical delivery (if it is a call), or to make physical delivery (if it is a put), of the underlying asset when the option is exercised. Upon exercise of a cash settled option, the buyer has the right to receive a settlement in cash in an amount equal to the difference, if any, between the value of the underlying asset determined at the time the option is exercised (i.e. current market price) and the strike price of the option. In the case of a call option, a cash settlement is only possible if the value of the underlying asset at the time the option is exercised exceeds the strike price of the option. In the case of a put option, a cash settlement is only possible if the value of the underlying asset at the time the option is exercised is less than the strike price of the option.

Exchange-traded options expire on a predetermined date, called the “expiration date.” OTC options typically expire on a date negotiated between the parties.

### Current Value of an Option

The relationship between the strike price of an option and the current market price of the underlying asset generally determines the value of the option. A call option is considered to be in-the-money if the market price of the underlying interest is higher than the strike price of the call option, at-the-money if the market price of the underlying asset is the same as the strike price, and out-of-the-money if the market price of the underlying asset is lower than the strike price. A put option is considered to be in-the-money if the market price of the underlying asset is lower than the strike price of the put option, at-the-money if the market price of the underlying asset is the same as the exercise price, and out-of-the-money if the market price of the underlying asset is higher than the exercise price.

### Pricing and Value of Options

The premium of an option is the purchase price paid by the buyer of the option to the seller. The premium generally is known to be affected by such variables as: (i) the current value of the underlying asset, (ii) the relationship between the value of the underlying asset and the exercise price, (iii) the current value of related assets, (iv) the anticipated future volatility of the underlying asset, (v) the historical volatility of the underlying asset, (vi) the amount of time remaining until expiration, (vii) current interest rates, (viii) the depth of the market for the option, and (ix) other factors that generally would affect price or volatility of any asset.

The value of an option generally consists of two components: (i) its intrinsic value and (ii) its time value. The intrinsic value reflects the amount, if any, by which the option is in-the-money. The time value is whatever the premium of the option is in addition to the intrinsic value.

An option's time value is known to be influenced by several factors, most notably the length of time remaining until the expiration date. An option is considered to be a “wasting” asset if it is not sold or exercised prior to its expiration date, when it becomes worthless. As a consequence, the value of an option usually decreases as the option approaches its expiration date, and this decrease accelerates as the time to the expiration date draws near. Another important factor in an option's time value is the volatility of the underlying asset to which it relates. Generally speaking, options on a more volatile asset will command a higher premium than an option on a less volatile asset. Finally, time value is influenced by the current cost of funds.

### General Risks of Options

An option buyer runs the risk of losing the entire amount of the premium paid for the option. This risk reflects the nature of an option as a “wasting” asset which may become worthless at its expiration date. An option buyer who does not exercise the option prior to its expiration date will necessarily lose the entire investment in the option. However, the option buyer can never lose more than premium paid for the option. The option writer, on the other hand, is obligated to purchase or sell the underlying asset or pay the cash settlement amount in the case of a cash-settled option if an option is in-the-money. In certain circumstances, this risk can be unlimited.

### Retirement Income Options

The present invention relates to a financial product and a method for hedging against changes in prospective retirement benefits. The financial product may be characterized as a semi-custom option that may be used to hedge against prospective changes in planned retirement finding sources. Planned retirement income covered by the option may include various retirement benefits, such as Social Security, withdrawal from retirement savings from plans and the like. With respect to Social Security retirement benefits, the option may be used to hedge against prospective changes in the benefit levels as well as the timing of retirement income benefit levels (“Social Security Options”). The option may also be used to hedge against reductions in anticipated returns derived from other retirement income funding sources, including defined contribution plans, such as 401(k) plans, 403(b) plans, employee stock ownership plans and profit sharing plans, thrift savings plans and other retirement savings plans (individually and collectively “retirement savings plans”). The option in accordance with the present invention can be used to hedge against fluctuations in all such retirement savings plans used for planning prospective retirement income (“Privately Funded Retirement Options”).

### Social Security Options

A Social Security Option is available for a premium, which is the amount the issuer of the option determines is appropriate for taking on the obligation to make future payments to a purchaser. In accordance with the present invention, multiple types of options may be available, each protecting against a distinct risk of a reduction in Social Security benefits. One option, an Overall Reduction in Benefit Investment Triggered Option (the “ORBIT Option”), provides a hedge against a reduction in overall Social Security retirement benefits to be received by the option purchaser. The ORBIT Option provides for a payment stream to a purchaser for a specified period of time in the event that the actual Social Security retirement benefits received under the Social Security system are less than the expected retirement benefits measured at the time the ORBIT Option is purchased.

Another option, hereinafter called a Change in Age of Social Security Eligibility Option (the “CASE Option”) provides a hedge against an increase in the age at which the purchaser becomes eligible to receive Social Security retirement benefits. If the age at which the purchaser of the option becomes eligible to receive Social Security benefits is increased, the CASE Option will provide for a payment stream to the purchaser for the period of time that Social Security benefits are not available. The specific timing of any such payments may be negotiated between the purchaser and the issuer of the particular option.

The ORBIT Option may be a modified European style option. Exemplary terms for such an option may be that the purchaser only may exercise the option if: (a) the purchaser reaches an age to be specified by the parties, (b) the purchaser begins receiving Social Security retirement benefits, (c) the In-the-Money Amount (as described below) is a positive number, and (d) the purchaser has paid the premium for such option in accordance with the terms agreed to with the issuer. Upon the happening of the foregoing events, the purchaser will have the right to exercise the option for as long a the purchaser continues to pay the premium. If the purchaser ceases paying the premium at any time, the option will expire and the issuer will have no payment obligations to the purchaser.

At the time the ORBIT Option is purchased, the issuer and the purchaser normally agree on the “Strike Price” of the Option, which will be a payment amount based upon the anticipated retirement benefits that the purchaser expects to receive upon becoming eligible for Social Security retirement benefits for a specified period (the “Calculation Period”). The Calculation Period may be monthly, annually or such other period as agreed between the purchaser and the issuer.

The In-the-Money Amount will be the amount, if any, by which the Strike Price exceeds the Social Security retirement benefits actually received by the purchaser for each Calculation Period. If the ORBIT Option is exercised, the issuer will be obligated to pay to the purchaser the In-the-Money Amount for each Calculation Period during the term of the Option. The term of the Option will be agreed upon by the parties and may be a fixed number of years or the payment obligation may continue until the death of the purchaser. The ORBIT Option may terminate automatically upon the death of the purchaser or it may provide for certain spousal benefits. In addition, if the premium is to be paid over time, a failure to pay the premium when due may result in the termination of the ORBIT Option.

The terms of the ORBIT Option may be subject to modification in the event of changes in law or regulations and may include other standardized terms as may be appropriate to establish the rights and obligations of the purchaser and the issuer.

The CASE Option may also be a modified European style option. Exemplary terms for such an option may be that the purchaser may only exercise the option if: (a) the purchaser reaches an age to be specified by the parties, (b) there has been an increase in the age at which the purchaser is eligible to begin receiving Social Security retirement benefits, and (c) the purchaser has paid the premium for such option in accordance with the terms agreed to with the issuer. Upon the happening of the foregoing events, the purchaser will have the right to exercise the option as long as the purchaser continues to pay the premium. If the purchaser ceases paying the premium at any time, the option will expire and the issuer will have no payment obligations to the purchaser.

At the time the CASE Option is purchased, the issuer and the purchaser will agree on the “Strike Price” of the Option, which will be a payment amount based upon the anticipated retirement benefits that the purchaser expects to receive upon reaching the age of eligibility for Social Security retirement benefits, assuming the eligibility age is not changed, for each Calculation Period.

If the CASE Option is exercised, the issuer will be obligated to pay to the purchaser an amount equal to the Strike Price for each Calculation Period from the date of exercise until the date on which the purchaser reaches the age at which the purchaser becomes eligible to begin receiving Social Security retirement benefits. The CASE Option may terminate automatically upon the death of the purchaser or it may provide for certain spousal benefits. In addition, if the premium is to be paid over time, a failure to pay the premium when due may result in the termination of the ORBIT Option.

The terms of the CASE Option may be subject to modification in the event of changes in law or regulation and will include such other standardized terms as may be appropriate to establish the rights and obligations of the purchaser and the issuer.

### Privately Funded Retirement Options

A Privately Funded Retirement Option is available for a premium, which is the amount the issuer of the option determines is appropriate for taking on the obligation to make future payments to a purchaser. In accordance with the present invention, three or more types of options may be available, each protecting against a distinct risk of a reduction in retirement savings plan benefits. A first exemplary option, the Decrease in Principal Option (the “DIP Option”), provides a hedge against a reduction in the principal amount of the purchaser's assets in a retirement savings plan. A second exemplary option, the High Water Mark Option (the “HWM Option”), provides a hedge against a reduction in the overall value of the purchaser's assets in a retirement savings plan from its highest point. A third exemplary option, the Guaranteed Amount Payout Option (the “GAP Option”), provides a hedge against a reduction in periodic payments from a retirement savings plan.

The DIP Option provides for a single payment to the purchaser in the future in the event that there has been a reduction in the purchaser's assets in a retirement savings plan in which the purchaser is a participant below the aggregate amount of the purchaser's contributions to such plan. The HWM Option provides for a single payment to the purchaser in the future in the event that there has been a reduction in the aggregate value of the purchaser's assets in retirement savings plan in which the purchaser is a participant below the highest value of such assets during the term of the option. The GAP Option provides for a series of payments to the purchaser in the event that the assets in the retirement savings plan are insufficient to provide to the purchase an anticipated level of periodic payments. The specific timing of any such payments may be negotiated between the purchaser and the issuer of the particular option.

The DIP Option may be a modified European style option. Exemplary terms for such an option may be that the purchaser only may exercise the option if (a) the total value of the purchaser's assets in a retirement savings plan have decreased below the Strike Price (as described below) and (b) the purchaser has paid the premium for such option in accordance with the terms agreed to with the issuer. Upon the happening of the foregoing events, the purchaser has the right to exercise the option as long as the purchaser continues to pay the premium. If the purchaser ceases paying the premium at any time, the option will expire and the issuer will have no payment obligations to the purchaser.

At the time the DIP Option is purchased, the issuer and the purchaser will agree on the “Strike Price” of the Option, which will be a specified dollar amount based upon the aggregate amount of the purchaser's contributions to a retirement savings plan. If the DIP Option is exercised, the issuer will be obligated to pay to the purchaser an amount equal to the Strike Price minus the actual value of the purchaser's assets in the retirement savings plan as of the exercise date (as such amount may be adjusted to account for withdrawals from the plan).

The term of the DIP Option may be subject to modification in the event of changes in law or regulation and will include such other standardized terms as may be appropriate to establish the rights and obligations of the purchaser and the issuer.

The HWM Option may be a modified European style option. Exemplary terms for such an option may be that the purchaser only may exercise the option if (a) the total value of the purchaser's assets in a retirement savings plan is below the Strike Price (as described below) and (b) the purchaser has paid the premium for such option in accordance with the terms agreed to with the issuer. Upon the happening of the foregoing events, the purchaser has the right to exercise the option as long as the purchaser continues to pay the premium. If the purchaser ceases paying the premium at any time, the option will expire and the issuer will have no payment obligations to the purchaser.

The “Strike Price” of the Option will be the highest value of all of the purchaser's assets in the plan during the term of the option. The Strike Price will be reset each time the value of such assets increase (either as a result of additional contributions to the plan or returns earned on assets in the plan). If the HWM Option is exercised, the issuer will be obligated to pay to the purchaser a single payment equal to the Strike Price minus the actual value of the purchaser's assets in the retirement savings plan as of the exercise date (as such amount may be adjusted to account for withdrawals from the plan).

The terms of the HWM Option may be subject to modification in the event of changes in law or regulation and will include such other standardized terms as may be appropriate to establish the rights and obligations of the purchaser and the issuer.

The GAP Option may be a modified European style option. Exemplary terms for such an option may be that the purchaser may only exercise the option if (a) the purchaser is eligible to make withdrawals from a retirement savings plan, (b) the periodic withdrawals of purchaser's assets from a retirement savings plan are below the Strike Price (as described below), and (c) the purchaser has paid the premium for such option in accordance with the terms agreed to with the issuer. Upon the happening of the foregoing events, the purchaser has the right to exercise the option as long as the purchaser continues to pay the premium. If the purchaser ceases paying the premium at any time, the option will expire and the issuer will have no payment obligations to the purchaser.

At the time the GAP Option is purchased, the issuer and the purchaser will agree on the “Strike Price” of the Option, which will be a specified periodic payment that the purchaser anticipates receiving from a retirement savings plan, assuming specified levels of contributions into such plan. If the GAP Option is exercised, the issuer will be obligated to pay to the purchaser a periodic payment equal to the Strike Price minus the actual periodic withdrawal from such plan by the purchaser (as such amount may be adjusted to account for early withdrawals from or reduced contributions to the plan).

The term of the GAP Option may be subject to modification in the event of changes in law or regulation and will include such other standardized terms as may be appropriate to establish the rights and obligations of the purchaser and the issuer.

### Offering of the Options

The options may be offered as semi-custom options to purchasers pursuant to an exemption from the registration requirements of the Securities Act of 1933, as amended (the “1933 Act”). Because each option will be individually tailored to the needs of each purchaser, each offer and sale of an option should be considered to be separate and distinct from all other offers and sales of the options and should not be integrated for purposes of the 1933 Act. A detailed risk disclosure statement will be provided that outlines for the purchaser the basic terms of the options and the risks involved with an investment in the options. A sample form of such a risk disclosure statement is set forth below. This disclosure statement is exemplary and merely relates to exemplary options and may be supplemented or modified by information necessary to describe the specific option that will be offered to the individual purchaser based upon that purchaser's unique requirements and situation. In addition, each purchaser will be required to complete an investor questionnaire, which will provide certain information about the purchaser's specific needs and interests to assist the applicant in tailoring each option to each purchaser.

### Sample Risk Disclosure Statement

### Special Characteristics of Retirement Income Options

Introduction

This document provides information regarding the features of certain options being offered and the risks in connection with purchasing such options. These options, referred to as “Retirement Income Options,” are being offered as a means to hedge against certain risks in connection with (i) a reduction in Social Security retirement benefits or a change in the timing of when such benefits may be received, and (ii) a reduction in anticipated returns derived from other retirement income funding sources. The options will be privately negotiated transactions between the issuer of the options (the “Issuer”) and each prospective purchaser and will not be listed or traded on any exchange. Because the terms of each option will be customized for the prospective purchaser, there will not be a public or other market for the options, nor is it likely that any such market will develop. Therefore, prospective purchasers must be aware that if they determine that they are no longer interested in holding an option, there will likely be no buyers for such option other than the Issuer, who has no obligation to repurchase the option.

Prospective purchasers should not construe the contents of this document as legal, tax or financial advice. Each prospective purchaser should consult his or her own professional advisers as to the legal, tax, financial or other considerations relevant to determining the suitability of Retirement Income Options for such prospective purchaser.

In deciding whether to purchase Retirement Income Options, prospective purchasers must rely on their own examination of the Issuer and the terms of the options, including the benefits and risks involved. These options have not been recommended, approved or disapproved by the Securities and Exchange Commission (the “SEC”), any state securities commission or any other regulatory authority. None of the foregoing authorities have passed upon, or endorsed the merits of, an investment in Retirement Income Options.

The options have not been registered with the SEC under the Securities Act of 1933, as amended (the “1933 Act”), or under the securities laws of any states, and are being offered and sold in reliance on exemptions from the registration requirements of the 1933 Act and such state laws. These options are subject to restrictions on transferability and resale, and may not be transferred or resold except as permitted under the 1933 Act and such applicable state securities laws, pursuant to registration or exemption thereunder.

Background

Many workers in the United States rely on Social Security retirement benefits as a source of some or all of their income upon retirement from the workforce. Currently, Social Security is the chief source of income for two-thirds of the elderly and almost the only source of income for one-third of the elderly. The Future Of Social Security, SSA Publication No. 05-10055, ICN 462560, March 2005.

To supplement Social Security benefits, many workers in the United States have established various forms of retirement savings, including defined contribution plans, such as 401(k) plans, 403(b) plans, employee stock ownership plans and profit sharing plans, thrift savings plans and other retirement savings plans. These plans are funded by the worker and/or the employer and such finds may be invested in a variety of investment alternatives. Workers typically anticipate that such investments will yield a level of return sufficient to provide additional income upon retirement from the workforce.

In recent years, concern has grown regarding the overall stability and solvency of the Social Security system. A variety of reform plans have been proposed to strengthen the Social Security system, many of which could result in a reduction in future benefits for retirees and/or changes in eligibility requirements. In addition, fluctuations and instability in the markets have resulted in poorer than anticipated returns (including, in many cases, negative returns) in many workers' retirement savings plans.

The Issuer is offering two types of Retirement Income Options to provide a hedge against risks of reduced retirement benefits related to the factors noted above. The first type of option, Social Security Options, will provide a hedge against changes in retirement benefits resulting from possible reforms to the Social Security system. The second type of option, Privately Funded Retirement Options, will provide a hedge against reductions in returns on funds maintained in retirement savings plans.

Options Terminology

This section contains a description of the standardized terms, and of some of the special vocabulary, applicable to options generally. Most of the terminology is the same for a wide variety of options.

An “option” is a contractual relationship between two parties giving one party the right, but not the obligation, to buy or sell a specified amount of an underlying asset at a specified price.

Options are traded on one of two mediums, on an exchange or over-the-counter (“OTC”). Standardized options, also referred to as “exchange-traded” or “listed” options, are traded on one or more options exchanges, and all such options have certain standardized terms. Transactions in standardized options settle and clear through the Options Clearing Corporation. OTC options are privately negotiated transactions between two parties, and the terms of the options are customized.

There generally are two types of options—puts and calls. An option that gives the holder a right to buy the underlying asset is referred to as a “call” option, and an option that gives the holder a right to sell the underlying asset is referred to as a “put” option. If the option can only be exercised at a specific point in the future it is considered a “European style” option, while an option that can be exercised at any point prior to expiration is considered an “American style” option.

The “exercise price,” also called the “strike price,” of an option is the price at which the buyer of an option may buy the underlying asset from the seller (in the case of a call option) or sell the underlying asset to the seller of an option (in the case of a put option).

Options may be either “physically settled” or “cash settled.” The buyer of a physically settled option has the right to receive physical delivery (if it is a call) or to make physical delivery (if it is a put) of the underlying asset when the option is exercised. Upon exercise of a cash settled option, the buyer will receive cash in an amount equal to the difference, if any, between the value of the underlying asset determined at the time the option is exercised and the strike price of the option. In the case of a call option, this payment will be made if the value of the underlying asset at exercise exceeds the strike price of the option. In the case of a put option, this payment will be made if the value of the underlying asset at exercise is less than the strike price of the option.

Exchange-traded options all expire on a certain predetermined date, called the “expiration date.” OTC options typically expire on a date negotiated between the parties. If an option has not been exercised prior to its expiration, the buyer of the option no longer has any rights to exercise, and the seller of the option no longer has any payment or delivery obligations.

The “holder” of an option is the party who has purchased an option.

The “writer” or an option is the party who has written the option.

The “premium” is the price that the holder of an option pays for the rights granted under the option and that the writer of the option receives for taking on the obligations under the option. In the listed options market, the holder and writer set the price in the market where the option is traded. The premium is not a standardized terms of the option. The premium does not reduce any future payment obligation of the parties and is non-refundable. Premiums change continuously in response to market and economic conditions.

An option is “at-the-money” if the current market value of the underlying asset equals the exercise price of the option. An option is “in-the-money” if the current market value of the underlying asset is above the exercise price in the case of a call option and below the exercise price in the case of a put option. “Out-of-the-money” means that the exercise price of a call is above the current market value of the underlying asset, or the exercise price of put is below the current market value of the underlying asset.

“Intrinsic value” is the amount, if any, by which an option is in-the-money. “Time value” is whatever the premium of the option is in addition to its intrinsic value.

Features of Options

Characteristics and Types of Options

A typical option is an agreement either to buy or to sell an underlying asset at a predetermined price on or before a specified date in the future. More specifically, an option contract gives the buyer or holder of the option the right, but not the obligation, to buy or sell an underlying asset at a specific price on or before a certain predetermined date, while the option seller or writer has an absolute obligation to perform under the option. An option's value depends on the value of the underlying asset or variable at a predetermined point in time in the future (e.g., the value of a stock option is based on the valuation of the underlying stock to which it refers).

Exchange-traded options are traded on a variety of organized exchanges in the United States. OTC options are privately negotiated bilateral contracts executed outside of the regulated exchange environment. There is no central marketplace or clearinghouse for OTC options. Market-makers, primarily large investment banks, commercial banks and institutional proprietary trading firms, create OTC options for use by a wide range of corporate, individual and institutional end-users.

Investors trading options or other derivative securities primarily are concerned with hedging the risk of adverse price and market fluctuations, which may affect their potential returns and positions in underlying assets. Investors may utilize exchange-traded options and OTC options for a variety of reasons, including the following:
Liquidity—to generate additional income from an existing asset and create a measure of downside protection.
Risk Reduction—to reduce or eliminate exposure to a change in the value of an asset.
Diversification—to reduce the risk of a concentrated position in an asset by investing in a more balanced, diversified portfolio.
Monetization—to increase liquidity by borrowing money using a protected position in an asset as collateral.
Tax Deferral—to avoid triggering a taxable sale of the position in the underlying asset, thereby deferring the capital gains tax associated with an outright sale of the asset.
   Pricing and Valuation of Options

The premium of an option is affected by such variables as: (i) the current value of the underlying asset, (ii) the relationship between the value of the underlying asset and the exercise price, (iii) the current value of related assets, (iv) the anticipated future volatility of the underlying asset, (v) the historical volatility of the underlying asset, (vi) the amount of time remaining until expiration, (vii) current interest rates, (viii) the depth of the market for the option, and (ix) other factors that generally would affect price or volatility of any asset.

The value of an option consists of two components: (i) its intrinsic value and (ii) its time value. The intrinsic value reflects the amount, if any, by which the option is in-the-money. The time value is whatever the premium of the option is in addition to the intrinsic value.

An option's time value is influenced by several factors, most notably the length of time remaining until expiration. An option is considered a “wasting” asset, meaning that if it is not sold or exercised prior to its expiration, it becomes worthless. As a consequence, the value of an option usually decreases as the option approaches expiration, and this decrease accelerates as the time to expiration shortens. A second important factor in an option's time value is the volatility of the underlying asset to which it relates. Generally speaking, options on a more volatile asset will command a higher premium than an option on a less volatile asset. Finally, time value is influenced by the current cost of funds.

Special Features of Retirement Income Options

Retirement Income Options may be used by prospective purchasers to hedge against possible changes in planned retirement income funding sources. Social Security Options provide a hedge against changes in Social Security retirement benefits, while Privately Funded Retirement Options provide a hedge against reductions in returns on funds maintained in retirement savings plans.

These options provide protection against an identifiable set of potential changes to retirement benefits. At the same time, each option is customized for the purchaser based upon the purchaser's age, income level, investment mix, desired return and other factors. The premium to be paid by the purchaser to the Issuer for these options will vary depending upon these factors. The premium payment may be structured as a periodic payment (e.g., monthly, quarterly, etc.) that is made from the date of purchase until the options is exercised. Alternatively, the premium may be paid in a lump sum at the time the option is purchased. The Issuer and the purchaser also may negotiate individualized premium payment terms.

Social Security Options

Two versions of Social Security Options are offered by the Issuer to hedge against changes in benefits resulting from possible reforms to the Social Security system, the Overall Reduction in Benefit Investment Triggered Option (the “ORBIT Option”) and the Change in Age of Social Security Eligibility Option (the “CASE Option”). In both cases, the underlying asset upon which these options are based is the purchaser's right to receive Social Security retirement benefits.

The ORBIT Option provides a hedge against a reduction in overall Social Security benefits to be received by the purchaser of the option. This type of option provides a payment stream to the purchaser for a specified period of time in the event that the actual Social Security retirement benefits received under the Social Security system are less than the expected retirement benefits measured at the time the ORBIT Option is purchased.

The ORBIT Option is a modified European style option. The purchaser only may exercise the option if: (a) the purchaser reaches an age to be specified by the parties, (b) the purchaser begins receiving Social Security retirement benefits, (c) the In-the-Money Amount (as described below) is a positive number, and (d) the purchaser has paid the premium for such option in accordance with the terms agreed to with the Issuer. Upon the happening of the foregoing events, the purchaser has the right to exercise the option for as long a the purchaser continues to pay the premium. If the purchaser ceases paying the premium at any time, the option will expire and the Issuer will have no payment obligations to the purchaser. (See “Exercise and Settlement” below for more information on how to exercise these options.)

At the time the ORBIT Option is purchased, the Issuer and the purchaser will agree on the “Strike Price” of the Option, which will be a payment amount based upon the anticipated retirement benefits that the purchaser expects to receive upon becoming eligible for Social Security retirement benefits for a specified period (the “Calculation Period”). The Calculation Period may be monthly, annually or such other period as agreed between the purchaser and the Issuer.

The In-the-Money Amount is the amount, if any, by which the Strike Price exceeds the Social Security retirement benefits actually received by the purchaser for each Calculation Period. If the ORBIT Option is exercised, the Issuer is obligated to pay to the purchaser the In-the-Money Amount for each Calculation Period during the term of the Option. The term of the Option will be agreed upon by the parties and may be a fixed number of years or the payment obligation may continue until the death of the purchaser. The ORBIT Option may terminate automatically upon the death of the purchaser or it may provide for certain spousal benefits. In addition, if the premium is to be paid over time, a failure to pay the premium when due may result in the termination of the ORBIT Option.

The terms of the ORBIT Option will be subject to modification in the event of changes in law or regulation and will include such other standardized terms as may be appropriate to establish the rights and obligations of the purchaser and the Issuer.

The CASE Option provides a hedge against an increase in the age at which the purchaser of the option becomes eligible to receive Social Security retirement benefits. If the age at which the purchaser of the option becomes eligible to receive Social Security retirement benefits is increased, this type of option provides for a payment stream to the purchaser for the period of time that Social Security benefits are not available.

The CASE Option is a modified European style option. The purchaser only may exercise the option if: (a) the purchaser reaches an age to be specified by the parties, (b) there has been an increase in the age at which the purchaser is eligible to begin receiving Social Security retirement benefits, and (c) the purchaser has paid the premium for such option in accordance with the terms agreed to with the Issuer. Upon the happening of the foregoing events, the purchaser has the right to exercise the option as long as the purchaser continues to pay the premium. If the purchaser ceases paying the premium at any time, the option will expire and the Issuer will have no payment obligations to the purchaser.

At the time the CASE Option is purchased, the Issuer and the purchaser will agree on the “Strike Price” of the Option, which will be a payment amount based upon the anticipated retirement benefits that the purchaser expects to receive upon reaching the age of eligibility for Social Security retirement benefits, assuming the eligibility age is not changed, for each Calculation Period.

If the CASE Option is exercised, the Issuer is obligated to pay to the purchaser the an amount equal to the Strike Price for each Calculation Period from the date of exercise until the date on which the purchaser reaches the age at which the purchaser becomes eligible to begin receiving Social Security retirement benefits. The CASE Option may terminate automatically upon the death of the purchaser or it may provide for certain spousal benefits. In addition, if the premium is to be paid over time, a failure to pay the premium when due may result in the termination of the ORBIT Option.

The terms of the CASE Option will be subject to modification in the event of changes in law or regulation and will include such other standardized terms as may be appropriate to establish the rights and obligations of the purchaser and the Issuer.

Privately Funded Retirement Options

Three versions of Privately Funded Retirement Options are offered by the Issuer to hedge against reductions in returns on funds maintained in retirement savings plans, the Decrease in Principal Option (the “DIP Option”), the High Water Mark Options (the “HWM Option”) and the Guaranteed Amount Payout Option (the “GAP Option”). The underlying asset upon which these options are based will be the value of the purchaser's assets in the relevant retirement savings plan.

The DIP Option provides a hedge against a reduction in the principal amount of the purchaser's assets in a retirement savings plan. This type of option provides for a single payment to the purchaser in the future in the event that there has been a reduction in the purchaser's assets in a retirement savings plan in which the purchaser is a participant below the aggregate amount of the purchaser's contributions to such plan.

The DIP Option is a modified European style option. The purchaser only may exercise the option if (a) the total value of the purchaser's assets in a retirement savings plan have decreased below the Strike Price (as described below) and (b) the purchaser has paid the premium for such option in accordance with the terms agreed to with the Issuer. Upon the happening of the foregoing events, the purchaser has the right to exercise the option as long as the purchaser continues to pay the premium. If the purchaser ceases paying the premium at any time, the option will expire and the Issuer will have no payment obligations to the purchaser. (See “Exercise and Settlement” below for more information on how to exercise these options.)

At the time the DIP Option is purchased, the Issuer and the purchaser will agree on the “Strike Price” of the Option, which will be a specified dollar amount based upon the aggregate amount of the purchaser's contributions to a retirement savings plan. If the DIP Option is exercised, the Issuer is obligated to pay to the purchaser an amount equal to the Strike Price minus the actual value of the purchaser's assets in the retirement savings plan as of the exercise date (as such amount may be adjusted to account for withdrawals from the plan).

The term of the DIP Option will be subject to modification in the event of changes in law or regulation and will include such other standardized terms as may be appropriate to establish the rights and obligations of the purchaser and the Issuer.

The HWM Option provides a hedge against a reduction in the overall value of the purchaser's assets in a retirement savings plan from its highest point. This type of option provides for a single payment to the purchaser in the future in the event that there has been a reduction in the aggregate value of the purchaser's assets in retirement savings plan in which the purchaser is a participant below the highest value of such assets during the term of the option.

The HWM Option is a modified European style option. The purchaser only may exercise the option if (a) the total value of the purchaser's assets in a retirement savings plan is below the Strike Price (as described below) and (b) the purchaser has paid the premium for such option in accordance with the terms agreed to with the Issuer. Upon the happening of the foregoing events, the purchaser has the right to exercise the option as long as the purchaser continues to pay the premium. If the purchaser ceases paying the premium at any time, the option will expire and the Issuer will have no payment obligations to the purchaser.

The “Strike Price” of the Option will be the highest value of all of the purchaser's assets in the plan during the term of the option. The Strike Price will be reset each time the value of such assets increase (either as a result of additional contributions to the plan or returns earned on assets in the plan). If the HWM Option is exercised, the Issuer is obligated to pay to the purchaser a single payment equal to the Strike Price minus the actual value of the purchaser's assets in the retirement savings plan as of the exercise date (as such amount may be adjusted to account for withdrawals from the plan).

The terms of the HWM Option will be subject to modification in the event of changes in law or regulation and will include such other standardized terms as may be appropriate to establish the rights and obligations of the purchaser and the Issuer.

The GAP Option provides a hedge against a reduction in periodic payments from a retirement savings plan. This type of option provides for a series of payments to the purchaser in the event that the assets in the retirement savings plan are insufficient to provide to the purchase an anticipated level of periodic payments.

The GAP Option is a modified European style option. The purchaser only may exercise the option if (a) the purchaser is eligible to make withdrawals from a retirement savings plan, (b) the periodic withdrawals of purchaser's assets from a retirement savings plan are below the Strike Price (as described below), and (c) the purchaser has paid the premium for such option in accordance with the terms agreed to with the Issuer. Upon the happening of the foregoing events, the purchaser has the right to exercise the option as long as the purchaser continues to pay the premium. If the purchaser ceases paying the premium at any time, the option will expire and the Issuer will have no payment obligations to the purchaser. (See “Exercise and Settlement” below for more information on how to exercise these options.)

At the time the GAP Option is purchased, the Issuer and the purchaser will agree on the “Strike Price” of the Option, which will be a specified periodic payment that the purchaser anticipates receiving from a retirement savings plan, assuming specified levels of contributions into such plan. If the GAP Option is exercised, the Issuer is obligated to pay to the purchaser a periodic payment equal to the Strike Price minus the actual periodic withdrawal from such plan by the purchaser (as such amount may be adjusted to account for early withdrawals from or reduced contributions to the plan).

The term of the GAP Option will be subject to modification in the event of changes in law or regulation and will include such other standardized terms as may be appropriate to establish the rights and obligations of the purchaser and the Issuer.

Required Documentation

In connection with the purchase of a Retirement Income Option, the purchaser will be required to enter into an Options Purchase Agreement with the Issuer, which will set forth the rights and obligations of the parties with respect to any options purchased from the Issuer In addition, a confirmation will be provided to the purchaser containing the specific details of the particular option purchased from the Issuer.

Exercise and Settlement

Because Retirement Income Options are OTC options, they are subject to exercise and settlement procedures that are very different from those applicable to listed options. Purchasers should understand and be familiar with the procedures described below. Purchasers should also be aware that the clearance and settlement of these options will be done directly with the Issuer and not through the Options Clearing Corporation, which clears and settles listed options.

Exercise Procedures

As noted above, all Retirement Income Options will be modified European style options. (Please note that the term “modified European style” option has been developed by the Issuer for use in describing the features of Social Security Options. It is not a standard options industry term.)

The right to exercise an Option is triggered by the happening of certain events. Upon the happening of such events, the purchaser of the option has the right to exercise as long as the purchaser continue to pay the required premium. Unlike an American style option, which may be exercised at any time during the term of the option, the purchaser of a Social Security Option may not exercise the option until a triggering event takes place. This type of option is distinct from a standard European style option in that once the triggering event occurs, the option may be exercised for a period of time rather than on a single date.

All Retirement Income Options must be exercised by the purchaser providing written notice of exercise to the Issuer. The options will not be subject to automatic exercise and if a purchaser fails to provide the required notice for any reason, the option will expire unexercised. In such event, even if the option is in-the-money, the Issuer will have no payment obligations with respect to the purchaser. Upon the purchase of a Retirement Income Option, the Issuer will provide to the purchaser detailed information regarding the notice requirements for the specific option being purchased.

Settlement Procedures

Upon the proper exercise of a Retirement Income Option, the Issuer will have a payment obligation to the purchaser. The purchaser will be required to provide to the Issuer appropriate payment instructions. Promptly after such exercise, the Issuer will calculate amount owed to the purchaser and will pay to the purchaser the payment amount within a specified period of time after such calculation is made.

Risks to Option Holders

All prospective purchasers should be aware of the risks involved with Retirement Income Options. The following is a brief summary of certain of those risks. This section is not intended to be all-inclusive; rather, it is intended to highlight certain of the more significant factors and special risks related to options.

Risks Involved with Retirement Income Options

Arm's Length Transaction. In purchasing a Retirement Income Option, the purchaser should understand that the Issuer is acting solely in the capacity of an arm's length contractual counterparty to the purchaser and not in the capacity of the purchaser's broker, agent, financial adviser or fiduciary. Consequently, in making an investment decision, purchasers must rely on their own examination of the Issuer, the transaction and the terms being offered, including the merits and risks involved in such a transaction.

Loss of Premium. An option purchaser runs the risk of losing the entire amount of the premium paid for the option. This risk reflects the nature of an option as a “wasting” asset which may become worthless at expiration. As noted above, certain triggering events must occur before a Retirement Income Option may be exercised. If one or more such events do not occur, the option is not exercisable. The purchaser will not receive back any portion of the premium paid for the option. However, the purchaser will never lose more than the premium paid.

Options Pricing. The price and characteristics of Retirement Income Options are individually negotiated between the Issuer and the purchaser and there is no central source to obtain prices from other dealers or market participants. In addition, the underlying assets for these options are unique to each purchaser. Accordingly, the purchaser has no means to determine whether the price quoted by the Issuer for the option is the best price available.

No Early Exercise Right. Because these options are European style or modified European style options, they may not be exercised prior to the Expiration Date or Exercise Period, as applicable. As a result, even if the option is in-the-money prior to that time, the option buyer may not realize the value of the option. Unlike listed options, which may be resold in the secondary market to realize value on an option prior to exercise, there is no secondary market for Retirement Income Options. The option buyer must wait until the option becomes exercisable before realizing its value.

Failure to Exercise. An option purchaser who does not exercise an option prior to its expiration will necessarily lose the entire investment in the option. Retirement Income Options do not have an automatic exercise feature and the purchaser must take affirmative measures to exercise the option. If the option is in-the-money and the purchaser fails to exercise in a timely manner, the Issuer has no obligation to make any payments due under the option.

Failure to Pay Premium. If the purchaser fails to pay the premium owed to the Issuer at any time during the life of the option, the option will terminate automatically. Upon such event, the purchaser will lose the value of such option, as well as the full amount of any premium previously paid to the Issuer.

No Public Market. There is no public or other market for Retirement Income Options, nor is it likely that any such market will develop. Purchasers must be aware that there is no means for them to resell such options prior to expiration. The Issuer may offer to repurchase such options from the purchaser, but it is under no obligation to do so and there can be no assurance that the price offered by the Issuer in connection with such repurchase will be reasonable.

Credit Risk. Unlike listed options, the purchaser of OTC options have significant credit exposure to the seller of the option. In the U.S. listed options market, the Options Clearing Corporation acts as the central clearinghouse for all options trades and guarantees the settlement of such trades. No such clearinghouse exists for OTC options and purchasers of OTC options must rely on the creditworthiness of the seller. Purchasers of Retirement Income Options should recognize that they are dependent upon the Issuer's ability to perform its payment obligations upon the exercise of the options. The Issuer could be unable to fulfill its payment obligations for a variety of reasons, including insolvency, regulatory constraints, and similar credit events. Purchasers must evaluate the credit of the Issuer prior to purchasing Retirement Income Options.

Long Term Nature of Options. It is anticipated that the time between the purchase of a Retirement Income Option and its exercise generally will be significant. During this time, many events could occur that could reduce or eliminate the benefit of holding the option, such as changes in laws, changes in the creditworthiness of the Issuer and changes in the financial position of the purchaser.

No Registration. The offering of Retirement Income Options has not been registered under the U.S. securities laws or the laws of any applicable jurisdiction. Therefore, purchasers do not have the benefit of all of the protections afforded by securities laws.

Other Activities of the Issuer. Purchasers should be aware that the Issuer will offer and sell Retirement Income Options to other persons and may engage in other activities in the securities markets. Such activities may expose the Issuer to risks and/or result in changes in the Issuer's business that could affect its ability to perform its obligations under the option or reduce its creditworthiness.

Risks Specific to Social Security Options

Early Termination. A Social Security Option will terminate upon the death of the purchaser. If such event occurs prior to the time when the option may be exercised, the purchaser's estate will realize no value from the option. If such event occurs after exercise but prior to the original termination date for the option, no further payments will be paid to the purchaser's estate.

No Lump Sum Payment. The payments required to be made by the Issuer upon exercise of a Social Security Option will be paid out over a number of years. The Issuer will not make a lump sum payment to the purchaser upon exercise. As a result, the purchaser will continue to be subject to credit risk for as long as such payments are made.

No Control over Changes in Social Security Benefits. Social Security Options have been developed to address two very specific possible changes in Social Security retirement benefits. If a purchaser chooses to purchase a Social Security Option and such specific change does not materialize, the purchased option may have no value. In addition, if other unanticipated changes are imposed on the Social Security system that reduce the purchaser's benefits, the purchased option will not protect the purchaser against such risks and the purchaser will continue to have exposure to those risks.

Risks Specific to Privately Funded Retirement Options

Restrictions on Adjustments to Investments. The Issuer may impose restrictions on the ability of the purchaser of a Privately Funded Retirement Option to make adjustments to the investment mix of the finds in the relevant retirement plan. This may result in returns that are more limited than could otherwise be obtained.

Withdrawals from Plans. A Privately Funded Retirement Option will be priced on the basis of the total assets in the relevant retirement savings plan at the time the option is purchased. If the purchaser withdraws assets from the plan prior to exercising the option, the Issuer will not refind to the purchaser any portion of the premium previously paid. In such event, the purchaser will not be able to realize on the value of a portion of the option that relates to assets that have been withdrawn.

Tax Considerations

The purchase of a Retirement Income Option may have tax implications for a purchaser. A purchaser should consult with his or her tax adviser to understand the tax consequences before purchasing a Retirement Income Option.

THIS DISCLOSURE STATEMENT DOES NOT PURPORT TO DISCLOSE ALL OF THE RISKS OR OTHER RELEVANT CONSIDERATIONS ASSOCIATED WITH PURCHASING RETIREMENT INCOME OPTIONS. A PROSPECTIVE PURCHASER SHOULD REFRAIN FROM PURCHASING SUCH OPTIONS UNLESS SUCH PURCHASER FULLY UNDERSTANDS THE ASSOCIATED RISKS AND INDEPENDENTLY DETERMINES THAT THE TRANSACTION IS APPROPRIATE.

### Method for Hedging Against Fluctuations in Planned Retirement Income Funding Sources

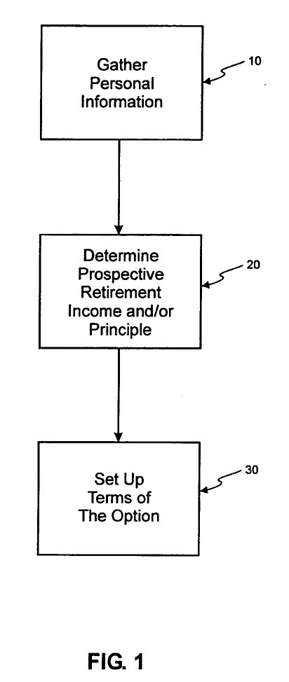

The present invention also relates to a method for hedging against fluctuations in finding sources for prospective retirement income. The method may be implemented by way of a personal computer. Referring to FIG. 1, the method is illustrated and is initiated by collecting personal information from an individual in step 10 relating to:
(a) an individual's current age
(b) an individual's current income level
(c) an individual's planned retirement age
(d) current funding sources available to the individual
(e) current investment mix in an individual's retirement savings plan
(f) spousal information including current age and planned retirement age as well as independent spousal funding sources.

In step 20, the data collected in step 10 (i.e., (a) through (f), as applicable)) is used to determine retirement income based upon current projected levels of Social Security retirement income as well as other funding sources. This defines the strike price of the option. Next in step 30, the terms of the option are defined for the particular funding sources(s) as set forth above.

Obviously, many modifications and various of the present invention are possible in light of the above teachings. Thus, it is to be understood that, within the scope of the appended claims, the invention may be practiced otherwise than is specifically described above.

We claim:

1. A method for hedging against fluctuations in prospective retirement income, the method comprising the steps of:
(a) gathering personal information from a prospective purchaser; including at least the purchaser's current age and current retirement funding source.
(b) determining prospective retirement income based upon said personal information; and
(c) issuing an option contract that will pay the purchaser of the option the difference between a strike price based upon a specified funding source and the current value, payments, returns or other features of the funding source.

2. The method as recited in claim 1, wherein step (a) comprises gathering additional personal information from a prospective purchaser selected from the group of, income level, an agreed-upon age at retirement and data on current Social Security retirement benefits.

3. The method as recited in claim 1, wherein step (a) comprises:
gathering personal information from a prospective purchaser; including at least the purchaser's current age and current anticipated Social Security benefits.

4. The method as recited in claim 1, wherein step (a) comprises:
gathering personal information from a prospective purchaser; including at least the purchaser's current age and current anticipated 401(k) benefits.

5. The method as recited in claim 1, wherein step (a) comprises:
gathering personal information from a prospective purchaser; including at least the purchaser's current age and current anticipated 403(b) benefits.

6. The method as recited in claim 1, wherein step (a) comprises:
gathering personal information from a prospective purchaser; including at least the purchaser's current age and current anticipated employee stock ownership plan benefits.

7. The method as recited in claim 1, wherein step (a) comprises:
gathering personal information from a prospective purchaser; including at least the purchaser's current age and current anticipated profit sharing plan benefits.

8. The method as recited in claim 1, wherein step (a) comprises:
gathering personal information from a prospective purchaser; including at least the purchaser's current age and current anticipated thrift savings plan benefits.

9. A financial product comprising: an option contract that provides a hedge against fluctuations in planned prospective retirement income funding source; the option contract based upon the purchaser's current age and a current retirement funding source.

10. The financial product as recited in claim 9, wherein said planned prospective retirement income funding source is Social Security retirement benefits.

11. The financial product as recited in claim 9, wherein said planned prospective retirement income funding source is retirement savings plans.

12. The financial product as recited in claim 9, wherein said planned prospective retirement income funding source is a 401(k) plan.

13. The financial product as recited in claim 9, wherein said planned prospective retirement income funding source is a 403(b) plan.

14. The financial product as recited in claim 9, wherein said planned prospective retirement income funding source is a employee stock ownership plan.

15. The financial product as recited in claim 9, wherein said planned prospective retirement income funding source is a profit sharing plan.

16. The financial product as recited in claim 9, wherein said planned prospective retirement income funding source is a thrift savings plan.

17. The financial product as recited in claim 9, wherein said fluctuations include the level of such benefits.

18. The financial product as recited in claim 9, wherein said fluctuations include the timing of such benefits.
